(19) United States
(12) Patent Application Publication
(10) Pub. No.: US 2006/0130912 A1
(43) Pub. Date: Jun. 22, 2006

(54) Three-way valve for liquids with abutting shutters

(76) Inventor: Alberto Lodolo, Genova (IT)

Correspondence Address: YOUNG & THOMPSON, 745 SOUTH 23RD STREET, 2ND FLOOR, ARLINGTON, VA, 22202, US

(21) Appl. No.: 10/545,401

(22) PCT Filed: Feb. 13, 2004
(86) PCT No.: PCT/IB04/00372

§ 371 Date: Aug. 12, 2005

(30) Foreign Application Priority Data
Feb. 14, 2003 (IT) MI2003A000275

(51) Int. Cl. F16K 11/044

(52) U.S. Cl. 137/625.27

(57) ABSTRACT

A three-way valve for the passage of liquids has an inlet, an outlet and a drain. An inlet opening connects the inlet to the outlet, whereas a drain opening connects the outlet to the drain. The inlet and drain openings can be alternatively closed by two shutters, rigidly connected to a mobile shaft. The mobile shaft has a normal flow position, in which the drain opening is closed by the drain shutter, while the inlet opening is free and allows communication between the inlet and the outlet, or a drain position, in which the inlet opening is closed by the inlet shutter and the drain opening is free and allows communication between the outlet and the drain. The drain forms a single piece with the valve and the shaft has an extension, that slides in a bore guiding the shaft's movement and keeping it centered in the right position.

The present invention relates to a three-way valve for the hydraulic field provided with abutment closure shutters, with the valve body and the drain duct made in one piece, and a mobile shaft, on which the two shutters are keyed, that is provided with an extension coming out of the valve body and having the function of keeping the mobile shaft centered, guiding the movement thereof and showing the position of the mobile shaft and therefore whether the valve is in the normal flow or in the drain position.

Three-way valves are widely used in the hydraulic field, since they allow to put in communication, upon driving, a duct with another while excluding a third one. In the backflushing of filters, for example, this type of valve is used when the water, which is usually the fluid flowing through the valve, is pumped in the reverse direction and it is required that the dirty water does not simply go back but flows down the drain, thus carrying away the dirt that had accumulated on the filters.

From U.S. Pat. No. 4,862,914 there is known a three-way valve for the cleaning of filters by pumping water in the reverse direction. Other three-way valves for liquids are known and commonly used in the hydraulic field.

The three-way valves presently existing in the hydraulic field or used in general for liquid media are all characterized by one or more sliding closure shutters. To go from the open position to the closed one, the shutter, provided with a peripheral gasket that in the closed position prevents leakage, is translated until it enters the opening with sliding tightness that, in some cases, must be provided with a draft and seal collar. In the shutter's closed position, the gasket is pressed against the inside walls of the opening, thus assuring the tightness.

A first drawback of this type of valve is that the shutter travel when passing from the closed position to the open one is quite long, since in the closed position the peripheral gasket on the shutter must be well inserted inside the opening.

Moreover, the sliding movement causes a significant wear of the sealing gasket. Furthermore, due to the friction caused by the sliding movement, an additional starting force is required to go from the closed position to the open position and vice versa.

In some cases, in order to obtain a sufficiently large passage cross-section without having too long a travel, a larger diameter of the opening and therefore of the shutter is selected, with the consequence that the drain duct has to be removable from the valve body to allow the mounting of the shutter, since the outlet diameter of the drain duct is defined by the diameter of the pipe to which it must be connected.

Finally, present hydraulically driven valves do not have a stem that, by coming out of the valve body, visually shows the valve operating state and that at the same time guides the shaft and the shutters in their movement.

Therefore the object of the present invention is to provide a valve which overcomes the above-mentioned drawbacks.

This object is achieved by means of a three-way valve for the passage of liquids that includes two abutment closure shutters. Other advantageous features are disclosed in the dependent claims.

A first advantage of the present valve comes from the lower wear of the sealing gasket thanks to the absence of sliding of the gasket that merely abuts on the sealing plane.

A second advantage of this type of valve is that, with the same passage cross-section and travel, it can have an opening and therefore a shutter of smaller diameter, which consequently allows to make the valve body and the drain duct in one piece. As an alternative, with the same cross-section a shorter travel is sufficient whereby the valve can be more compact and quicker in the operation.

A further advantage, in the case of hydraulically driven valves, is given by the passage of the stem, extension of the mobile shaft on which the shutters are rigidly connected, outside the valve body so as to provide also a visual indication of the shaft position and therefore of the position of the shutters.

On the other hand, in case of manually driven valves, the cover and valve body can be a single piece, thus achieving a saving in the number of pieces.

The two shutters and the length of shaft connecting them can be made in one piece, for example of a plastic material, with an axial bore that allows the introduction of the mobile shaft, usually of metal, thus achieving greater simplicity in manufacturing and mounting. A sealing ring suitable to allow or to make easier the mounting may be present, depending on the manufacturing solution that is chosen.

These and other advantages and characteristics of the valve according to the present invention will be clear to those skilled in the art from the following detailed description of some embodiments thereof, with reference to the annexed drawings wherein:

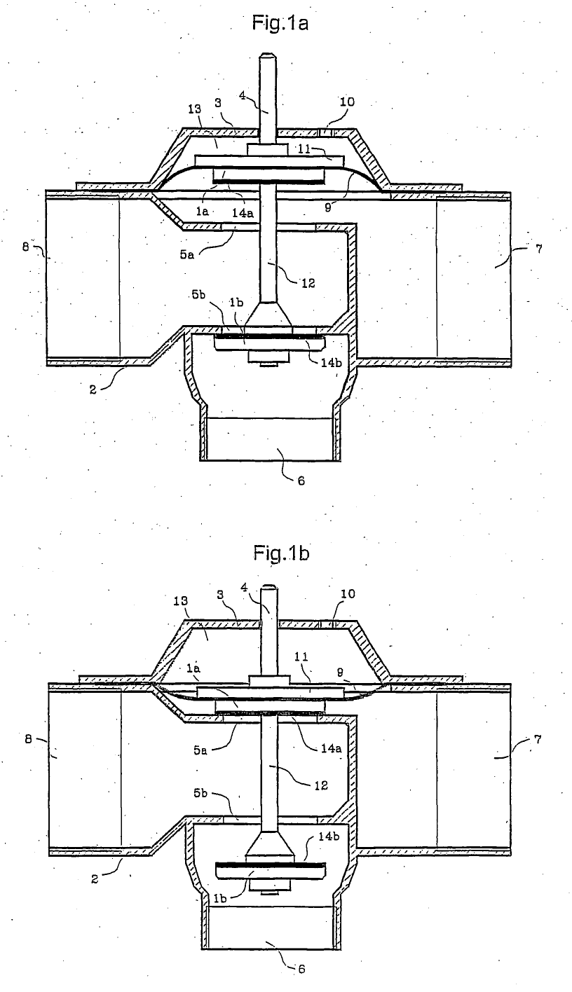

FIG. 1a is a diagrammatic vertical sectional view of a first embodiment of a valve according to the invention with external shutters and hydraulically driven, in normal flow position;

FIG. 1b is a diagrammatic vertical sectional view of the same valve of FIG. 1a in drain position;

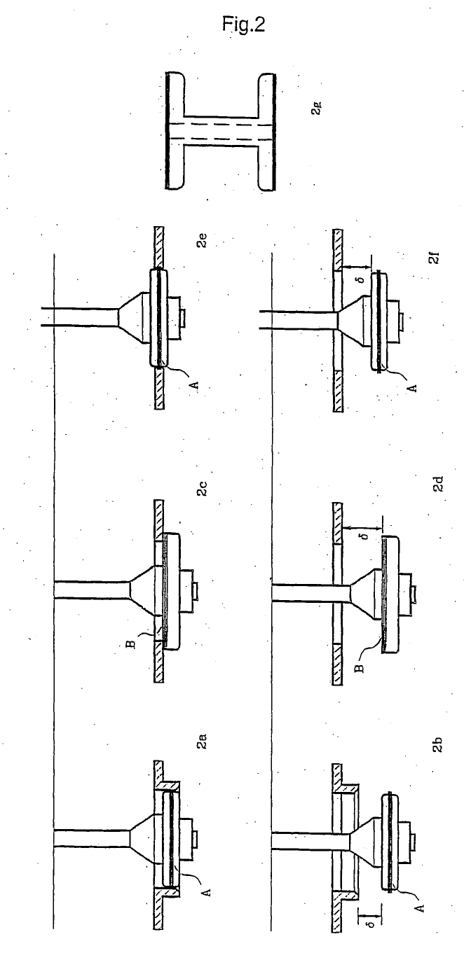

FIGS. 2a and 2b show an example of sliding closure shutter in the closed position (FIG. 2a) and in the open position (FIG. 2b);

FIGS. 2c and 2d show an example of abutment closure shutter in the closed position (FIG. 2c) and in the open position (FIG. 2d);

FIGS. 2e and 2f show an example of collarless sliding closure shutter in the closed position (FIG. 2e) and in the open position (FIG. 2f);

FIG. 2g shows a variation with the two internal shutters made in one piece, preferably of plastic material, with an axial bore for the introduction and securing of the mobile shaft;

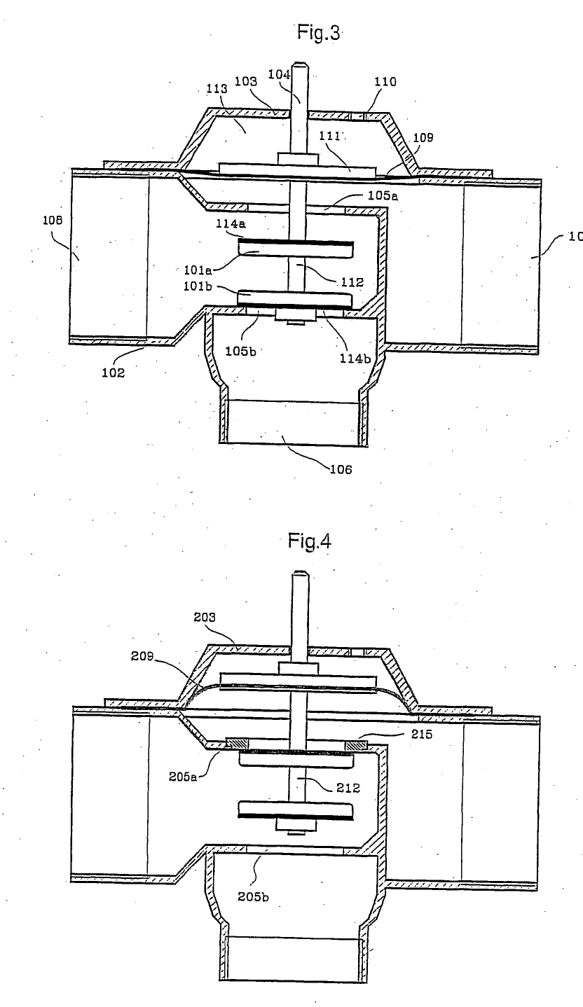

FIG. 3 is a diagrammatic vertical sectional view of a second embodiment of a valve according to the invention with internal shutters and hydraulically driven, in normal flow position;

FIG. 4 is a diagrammatic vertical sectional view of a variation of the preceding valve, including a sealing ring on the inlet opening, in drain position;

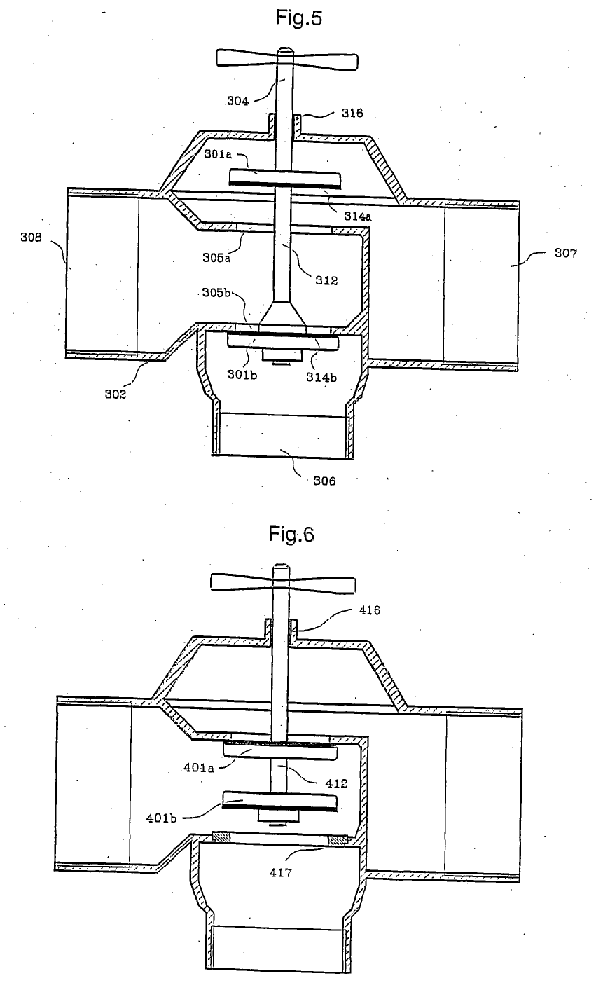

FIG. 5 is a diagrammatic vertical sectional view of a third embodiment of a valve according to the invention with external shutters and manually driven, in normal flow position; and

FIG. 6 is a diagrammatic vertical sectional view of a fourth embodiment of a valve according to the invention with internal shutters and manually driven, including a sealing ring on the drain opening, in drain position.

With reference to said figures, there is illustrated here a three-way valve for the passage of liquids with an inlet (7), an outlet (8) and a drain (6), as shown in FIG. 1. The inlet opening (5a) connects the inlet (7) to the outlet (8), whereas the drain opening (5b) connects the outlet (8) to the drain (6). The two inlet and drain openings (5a, 5b) can be alternatively closed by two abutment closure shutters, an inlet one (1a) and a drain one (1b), rigidly connected to a mobile shaft (12). The relevant gaskets (14a, 14b) allowing the sealing in the abutment closure position are also shown in the figures.

The mobile shaft (12), with the two shutters (1a, 1b) rigidly connected thereto, can be taken to the normal flow position (FIG. 1a), in which the drain opening (5b) is closed by the drain shutter (1b), while the inlet opening (5a) is free and allows the communication between the inlet (7) and the outlet (8); or it can be taken to the drain position (FIG. 1b), in which the inlet opening (5a) is closed by the inlet shutter (1a) and the drain opening (5b) is free and allows the communication between the outlet (8) and the drain (6).

The valve body (2) and the drain (6) are made in a single piece, and the valve can be hydraulically (as in FIG. 1, FIG. 3 and FIG. 4) or manually (as in FIG. 5 and FIG. 6) driven.

In the case of hydraulically driven valve, by the same controlled fluid or by another fluid, there is present a cover (3) that encloses the top of the valve and allows to mount a deformable membrane (9), usually of rubber material, clenched by the cover against the valve body and connected to the mobile shaft through a driving disk (11). In FIGS. 1a, 1b the deformable membrane (9) is pressed against the top surface of the inlet shutter (1a). When the shutters are internal, as in the case depicted in FIG. 3 and FIG. 4, the driving disk can be formed by two disks between which the deformable membrane is pressed so as to move together with the driving disk.

The chamber (13) defined by the membrane (9) can be filled with pressurized liquid thus causing a downward movement of the driving disk (11) and of the mobile shaft (12). In the case where the chamber (13) is not filled with pressurized liquid, the pressure of the liquid flowing on the other side of the membrane (9) causes an upward movement of the driving disk (11) and of the mobile shaft (12).

In the case where the valve is manually driven, the cover (3) may be present, for ease of mounting, or not, whereby, in the latter instance, the valve body (2) is closed at the top. In such a case the stem (4) is threaded and a manual rotation thereof, for example by means of a wheel fixed thereon, shifts the mobile shaft upwards or downwards, taking the valve to the normal flow or drain position (FIGS. 5, 6). In this case the stem (4) in addition to carrying out the above-mentioned functions, guiding the mobile shaft (12), keeping it in the right position and acting as an indicator of the valve position, is also the member through which the upward or downward movement of the mobile shaft (12) is determined.

The stem (4), even in the case of hydraulic drive, in addition to guiding and keeping centered the mobile shaft (12), indicates the position of the mobile shaft (12) and therefore indicates whether the valve is in the normal flow position (FIG. 1a), with open inlet opening (5a) and closed drain opening (5b), or in drain position (FIG. 1b), with closed inlet opening (5a) and open drain opening (5b).

The advantage in using an abutment closure rather than a sliding closure is shown in FIG. 2. In FIG. 2a there is illustrated a sliding shutter in closed position, in FIG. 2b a sliding shutter in open position, in FIG. 2c an abutting shutter in closed position, in FIG. 2d an abutting shutter in open position.

The O-ring of the sliding shutter is indicated in the figure by reference A, whereas the annulus-shaped gasket for the abutment closure shutter is indicated in the figure by reference B. The position of the two shutters is the same, but the opening of the sliding shutter has a collar which the shutter in closed position must enter. The collar must also have a draft to prevent damage to the gasket in the closing step.

It can be noted that with the same travel the sliding closure shutter has a smaller aperture δ. Alternatively, when fixing the same aperture δ for the two types of shutter, the sliding shutter has a longer travel. When fixing the same travel for the two shutters, in order to have the same passage cross-section for the liquid (passage cross-section=πDδ, where D is the diameter of the opening), it is necessary that the opening with sliding closure, and consequently its shutter, has a diameter greater than the opening with abutment closure. In fact, assuming that the δ aperture with abutment is n times the δ aperture with sliding, where actually due to the limited range of travel n≅1.5÷2, by setting the two passage cross-sections equal, there is obtained that Dₜ=Dₛ/n, where Dₜ is the diameter with abutment closure and Dₛ is the diameter with sliding closure. Obviously, the diameter of the abutting shutter must be slightly greater than the diameter of the opening, to achieve the abutment closure.

If the plate with the opening is sufficiently thick, the collar can be dispensed with in the case of sliding closure, but the closed position of the sliding shutter would be different from the closed position of the abutting shutter, in that it must enter the opening, whereby, with the same travel, the sliding shutter would still have an aperture δ smaller with respect to that of the abutting shutter. (FIGS. 2e, 2f).

In some cases a smoother operation of the valve can be achieved by shaping the shutter so that, in the closed position, it partially enters the opening, while retaining the abutment closure by means of an annulus-shaped gasket.

Therefore the abutment closure shutter allows to obtain, with the same travel and liquid passage cross-section, a smaller diameter of the opening and shutter. This results very useful in that, in some cases of sliding closure, the large diameter of the drain shutter, greater than that of the drain duct, requires the manufacturing of a drain duct removable from the valve body, in order to allow the mounting of the shutter on the shaft. In fact the drain diameter is defined by the diameter of the pipe to which it is connected.

Another advantage of the abutment closure system is less wear of the sealing gasket, which does not slide on the internal surface of the opening to be closed. Furthermore, for the same reason, the force required to open or close the valve is lower and the valve can be more readily opened.

FIG. 2g illustrates the case where the two internal shutters are made in a single piece. On the axis there is provided a bore to receive the mobile shaft that must be connected thereto.

Since the mobile shaft (12) can be moved through a manual system or through an hydraulic system, and the shutters (1a, 1b) can be arranged both on the outside or both on the inside of the respective inlet and drain openings (5a, 5b), you can have at least four main embodiments of the present invention depicted in FIG. 1, FIG. 3, FIG. 5 and FIG. 6.

Each of them can have several variations (e.g., a variation of the main embodiment of FIG. 3 is illustrated in FIG. 4) given by the combination of more elements, such as the presence of a sealing ring or the fact that the cover is removable or on the contrary is made in one piece with the valve body.

In the case of hydraulic drive, when properly pressurized liquid is fed to the chamber (13) through the opening (10), coming for instance from a pipe connected upstream from the inlet (7), the valve reaches the drain position of FIG. 1b. When the chamber (13) is put in communication with the environment at atmospheric pressure, the liquid in the chamber (13) flows out and the valve reaches the normal flow position shown in FIG. 1a.

The cover (3) has a central bore to let out the stem (4), extension of the shaft (12), so that the working position of the valve can also be visually recognized. An important function of the stem (4) is to guide the shaft (12) in its movement and to keep it in the right position. Obviously, it is not necessary that the outlet bore of the stem (4) be at the center of the cover (3). The stem (4), rigidly connected to the shaft (12), could also have a prismatic type of engagement with the bore, to prevent rotations, and be offset with respect to the shaft (12) and the bore would be correspondingly positioned.

In this embodiment of the invention, the drain shutter (1b) can be mounted on the shaft (12) through the drain (6), since the drain shutter (1b) has a diameter smaller than the drain (6) and the drain duct is a single piece with the valve body (12). On the other hand, the inlet shutter (1a) can be mounted on the shaft (12) through the opening in the valve body when the cover has not been mounted yet.

In FIG. 3 there is illustrated the valve according to the invention with hydraulic drive and internal shutters, in the normal flow position. Also in this case, as in the preceding case, the valve is provided with a bored cover (103) to let the stem (104) out, with a rubber membrane (109) and with a driving disk (111). The driving disk (111) is divided into two disks so that the deformable membrane (109) can be pressed therebetween and follows the movement of the mobile shaft (112).

The operation is similar to the preceding one but inverted. When the chamber (113) is filled with pressurized liquid the membrane (109) and the driving disk (111) move downwards, the drain shutter (101b) closes the drain opening (105b) and the inlet shutter (101a) opens the inlet opening (105a) placing the valve in normal flow position. When the chamber (113) is emptied the membrane (109) and the driving disk (111) move upwards, the drain shutter (101b) opens the drain opening (105b) and the inlet shutter (101a) closes the inlet opening (105a) placing the valve in drain position.

In this embodiment of the invention the two internal shutters (101a, 101b) can be made in a single piece as shown in FIG. 2g, preferably of plastic material, that results in a saving both in the manufacturing and mounting steps. The length connecting the two shutters has to be hollow so as to allow the keying onto the mobile shaft, which is usually made of metal. The two shutters (101a) and (101b), made in a single piece, can be mounted by introducing and positioning them in the valve body through the outlet (108), if the size allows for this, and the shaft (112) can be connected thereto subsequently.

As an alternative, and more easily, the mounting can take place through the drain (106) and the drain opening (105b) by arranging, after the mounting, a sealing ring on the drain opening (105b) to reduce the size thereof and thus allow the abutment closure. Still more easily, the mounting can take place through the top opening prior to the mounting of the cover (103) and through the inlet opening (105a) by arranging, after the mounting, a sealing ring on the inlet opening (105a) to reduce the size thereof and thus allow the abutment closure. FIG. 4 shows this latter case where the valve has a sealing ring (215) on the inlet opening (205a).

Clearly the valve must be manufactured taking into account the mounting in one of the above-mentioned manners, therefore having suitable diameters for the inlet and drain openings and the possible sealing rings.

In FIG. 5 there is illustrated the valve according to the invention with manual drive and external shutters, in the normal flow position. In the case in this figure the manual drive is provided through a wheel that, thanks to a screw system (316), allows to move the shaft (312) and the two shutters (301a) and (301b) connected thereto from the normal flow position to the drain position and vice versa.

In the case of manual drive there is no rubber membrane and therefore also a removable cover and a driving disk as in the preceding cases are not necessarily present, whereby the valve can be closed at the top. The cover at the top portion of the valve can be made in a single piece with the valve body (302), even if, for mounting needs, it can be useful to have a removable cover as above.

In FIG. 6 there is illustrated the valve according to the invention with manual drive and internal shutters, in drain position. The figure shows the case where a sealing ring (417) is present on the drain opening. Also here, as in the preceding case, a manual drive is provided through a wheel that, thanks to a screw system (416), allows to move the shaft (412) and the two shutters (401a) and (401b) connected thereto from the normal flow position to the drain position and vice versa.

Also in this manual drive embodiment there is no rubber membrane, and therefore also a removable cover is not necessarily present, whereby the valve body and the cover are made in a single piece. However in this case the mounting can easily be carried out even without the presence of a removable cover.

The two shutters (401a, 401b) can advantageously be made in a single piece and the mobile shaft (412) is subsequently connected thereto. The mounting and positioning of the two shutters (401a, 401b) forming a single piece can take place through the outlet without sealing rings, if the size allows for this, or through the drain by providing a sealing ring (417) on the drain opening, so as to allow the mounting of the single piece through the drain opening and then subsequently reduce the diameter of the drain opening to allow the abutment closure.

The advantage of making the two shutters (401a, 401b) in a single piece is again underlined, resulting in advantages both in manufacturing and mounting, and there are various possibilities with their combinations: for example you can have a removable cover, or you can have no sealing rings, or you can have a sealing ring on the inlet opening or on the outlet opening.

In the different embodiments the two shutters, as well as the driving disk, can be advantageously made of plastic material, thus achieving a decrease in manufacturing cost, weight and therefore also in delivery cost.

It is clear that the above-described and illustrated embodiments of the valve according to the invention are just examples susceptible of various modifications. Therefore, possible additions and/or modifications may be made to the valve of the present invention, yet without departing from the scope of protection of the invention.

1-7. (canceled)

8. Inline three-way valve for the passage of liquids, including a valve body (2) with an inlet (7), an outlet (8), a drain (6), an inlet opening (5a) that connects said inlet (7) to said outlet (8), and a drain opening (5b) that connects the outlet (8) to said drain (6), so that said two inlet (5a) and drain (5b) openings can be alternatively closed by two shutters, an inlet shutter (1a) and a drain shutter (1b), rigidly connected to a mobile shaft (12), said two shutters (1a, 1b) being made so as to perform an abutment closure of the respective openings (5a, 5b) characterized in that said valve is hydraulically driven and it includes a chamber (13), formed on the top of the valve by a cover (3) and by a deformable membrane (9), connected to the mobile shaft (12) through a driving disk (11) and clenched against the valve body, said chamber (13) being alternatively connected through an opening (10) by a pipe to the fluid entering the valve or to the environment at atmospheric pressure, said deformable membrane (9) on the side opposite to that of the chamber (13) being in contact with the liquid flowing from the inlet (7).

9. Valve according to claim 8, characterized in that the mobile shaft (12) is supported on a single side.

10. Valve according to claim 8, characterized in that the drain duct forms a single piece with the valve body (2).

11. Valve according to claim 8, characterized in that at least an extension of the mobile shaft (12), called stem (4), comes out of the valve sliding through a bore formed in the valve body (2) and is secured thereon.

12. Valve according to claim 8, characterized in that the shutters (101a, 101b) are made in a single piece, with an axial bore that allows the introduction and securing of the mobile shaft (112) during the mounting step.

13. Valve according to claim 8, characterized in that a sealing ring (215, 417) is provided on the inlet or drain opening (5a, 5b) to allow the mounting.

14. Valve according to claim 8, characterized in that the driver (11) and the two shutters (1a, 1b), are made in a single piece.

15. Valve according to claim 8, characterized in that the driver (11) and the two shutters (1a, 1b) are manufactured from a plastic material.

16. Valve according to claim 9, characterized in that at least an extension of the mobile shaft (12), called stem (4), comes out of the valve sliding through a bore formed in the valve body (2) and is secured thereon.
